(19) United States
(12) Patent Application Publication
(10) Pub. No.: US 2014/0032400 A1
(43) Pub. Date: Jan. 30, 2014

(54) Mobile Savings Account

(71) Applicant: Vodafone IP Licensing Limited, Berkshire (GB)

(72) Inventors: Peter CORNFORTH, Berkshire (GB); Jason DOWNING, Berkshire (GB); Gregory REEVE, Berkshire (GB)

(73) Assignee: Vodafone IP Licensing Limited, Berkshire (GB)

(21) Appl. No.: 13/947,363

(22) Filed: Jul. 22, 2013

(30) Foreign Application Priority Data
Jul. 20, 2012 (GB) 1212918.5

(51) Int. Cl. G06Q 20/32

(52) U.S. Cl. CPC G06Q 20/3223
USPC 705/39

(57) ABSTRACT

System and method of operating a savings account 20 within a mobile telephone based money transfer system. Receiving separate payments across the mobile telephone based money transfer system from a plurality of contributors. Crediting the received separate payments to the savings account 20.

### FIELD OF THE INVENTION

The present invention relates to a system and method of operating a savings account within a mobile telephone based money transfer system.

### BACKGROUND OF THE INVENTION

Social group savings and loans are popular across Africa, specifically within the East African countries of Kenya, Tanzania and Uganda, but they also exist in South Africa (called Stokvel groups). Group saving involves a number of people individually saving as a team; they may use these savings as a loan (either within the group or externally). Typically, each member saves a set amount over the loan period and then receives their share of interest once the loan is repaid. Another form of group savings (called rotary savings) allows a group of users to all contribute a set amount into a pool which is then paid to an individual (within the group) each month. In each case, it is the intension that social pressure ensures that each member will save. These saving mechanisms are largely used by financially excluded people and provide a structured way to save and the ability to earn interest on their savings.

However, as these saving schemes are run informally without legal structures, there are opportunities for money to go missing through either mismanagement or misappropriation. Management of outstanding payments over a set period can become complex if individuals fall behind on payments. Occasionally, other group members may make up the difference, resulting in different pay-outs and further complexity. In summary, whilst these schemes are very useful, they are not secure, rely on trust, and introduce complexity and difficulty in administration. Furthermore, accountability and traceability of transactions is difficult or impossible to implement.

Existing social group savings services may be informal and usually work in the following manner. A group of individuals agree to start a group saving club with contributions periodically. The group usually commit to a saving period that is the contribution period, times the number of members within the group. This means that each member gets a pay out of a full amount over the period. Groups usually meet once a contribution period to provide cash payments to the administrator of the group (a selected individual within the group). As owner of the funds the administrator of the group accepts a level of responsibility.

However, this scheme has at least the following drawbacks:
Security risks of cash and cash handling;
Security risks of the administrator losing or stealing group funds;
Manual management of the scheme including payments in and out; and
The scheme involves members or contributors having to physically meet to contribute funds.

Therefore, there is required a system and method that overcomes these problems.

### SUMMARY OF THE INVENTION

Against this background and in accordance with a first aspect there is provided a method of operating a savings account within a mobile telephone based money transfer system comprising the steps of:
receiving separate payments across the mobile telephone based money transfer system from a plurality of contributors; and
crediting the received separate payments to the savings account. Therefore, a group savings scheme may be implemented with improved security, transparency and traceability.

A mobile telephone based money transfer system savings account is a savings account within a mobile based money transfer system. The savings account is not associated with a bank account, current account, credit card account, debit card account, pre-paid card issued by a financial institution or another type account within a financial institution. In other words, each user of the mobile telephone based money transfer system may have their own account within the system but they do not require or need to have access to a bank account or similar account to hold, transfer or process funds. Instead, the funds remain within the mobile based money transfer system unless they are exchanged for goods and services or withdrawn, usually as cash from an agent. Funds may also be transferred to other accounts within mobile telephone based money transfer system without requiring processing from a financial institution. Therefore, the mobile telephone based money transfer system does not require branches or an ATM network. Typically, there will be no transaction fee for fund transfers within the system.

Preferably, the method may further comprise the step of recording the separate payment amounts with their corresponding contributor. These may be stored or communicated to the contributors.

Advantageously, the method may further comprise the step of adding a contributor to the savings account. Contributors or members may be added or removed.

Optionally, the method may further comprise the step of generating a notification when the contributor is added to the savings account. Notifications may also be provided when contributors are removed from the savings account.

Optionally, the method may further comprise the step of generating a notification when the separate payments are received or when funds are debited from the savings account.

Optionally, the method may further comprise the step of issuing a notification of an invitation to one or more potential contributors to the savings account.

Preferably, the notification may be an SMS message to the contributors. The notifications (of any or all types) may be sent to a distribution list associated or saved with the savings account. Therefore, any such notifications may be preferably sent all parties on the distribution list. The distribution list may comprise all contributors, a subset of contributors or anyone with an interest in the savings account, for example.

Preferably, the method may further comprise the step of creating the savings account within the mobile telephone based money transfer system before receiving the separate payments. The savings account may be created by an administrator who may be one of the contributors. There may be a secondary or deputy administrator with the same privileges.

Optionally, the step of creating the savings account may further comprise any one or more of:
specifying identities of the contributors;
specifying MSISDN of the contributors;
specifying a payment date or dates;
specifying a payment period;
specifying amount or amounts of the separate payments; and
specifying a regular interval for payments from the savings account. Other steps may be included.

Preferably, the method may further comprise the step of debiting funds from the savings account.

Optionally, the funds may be debited at regular intervals. The funds may also be debited at other intervals or when required.

Optionally, the funds may be debited to the contributors in turn.

According to a second aspect there is provided a mobile telephone based money transfer system comprising:
a database of a plurality of savings accounts; and
a server having logic configured to:
   receive separate payments across the mobile telephone based money transfer system from a plurality of contributors; and
   credit the received separate payments to one of the plurality of savings accounts.

Optionally, the mobile telephone based money transfer system may further comprise a notifier configured to provide notifications to the plurality of contributors when actions occur on their savings account. This savings account is the combined or groups savings accounts.

Preferably, the mobile telephone based money transfer system may further comprise a menu provider configured to provide menus on mobile telephones of the contributors, wherein the menu is provided in the form of any one or more selected from the group consisting of:
SIM tool kit, STK;
Unstructured Supplementary Service Data, USSD; and
Interactive Voice Response, IVR.

The methods described above may be implemented as a computer program comprising program instructions to operate a computer. The computer program may be stored on a computer-readable medium or sent as a signal.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a method of operating a savings account within a mobile telephone based money transfer system;

FIG. 2 shows a schematic diagram of further aspects of the method of FIG. 1;

FIG. 3 shows a schematic diagram of further aspects of the method of FIG. 1; and

FIG. 4 shows a schematic diagram of a mobile telephone based money transfer system.

It should be noted that the figures are illustrated for simplicity and are not necessarily drawn to scale.

### DETAILED DESCRIPTION OF THE PREFERRED EMBODIMENTS

Cell phone based money transfer systems such as M-PESA provide a facility for transferring funds between mobile users. Cash may be exchanged for electronic money, which may be sent to family and friends, to pay bills or to purchase mobile air-time, for example. Such systems are designed to work on limited functionality mobile handsets using an installed SIM toolkit (STK) to provide additional menus dedicated to funds transfer, Unstructured Supplementary Service Data (USSD) sessions or interactive voice response (IVR) systems. SMS messages may be used to confirm to a sender and a receiver that an amount has been transferred following a transaction or payment. Cash may be redeemed or exchanged for electronic money (or “e-money”) at outlets, which may be grocery stores or air-time resellers, for example.

An example of such a system is described at: http://www.vodacom.co.za/personal/services/m-pesa/aboutm-pesa

Such money transfer systems are typically in use in countries with a limited banking infrastructure, where the population may not have access to basic financial services.

Group or social savings may be delivered using money transfer system to improve security and accountability of persons running such services. Using mobile technology to deliver such services provides improved management of such schemes including scheme enrolment, administration, transaction traceability and tracking.

Using a mobile telephone based money transfer system in such group savings reduces:
security concerns around cash savings payments that have been made to one individual; and
security concerns around being able to trace funds that have may have been misplaced or misappropriated.

Management of scheme may include the following activities:
Enrolment of users or contributors into the scheme;
Collection of savings amounts;
Disbursement of savings amounts;
Processes to manage late payments;
Processes to manage removal of members or contributors from the savings scheme; and
Reporting of scheme progress throughout the savings cycle.

A mobile telephone based money transfer system may be used to pool funds into one account, which may be managed by an assigned administrator. Members of the scheme may use their existing mobile money transfer accounts to fund their savings payments into the scheme, utilising an existing cash-in and out network.

Particular features of the system include:
Use of low end mobile technologies such as STK, USSD and IVR, for example to set up the savings scheme;
Use of low end mobile technologies (STK, USSD, IVR) to manage enrolment into scheme for new members;
Creation of a pooled account within mobile money transfer solution to collect and disburse savings payments;
Assignment of a primary administrator who has access and privileges to initiate payments out of the savings account and the assignment of a secondary administrator who may have access to authorise the initiated payments. This may provide further control of the funds and reduce abuse of the account. It may also provide control to define who can receive payments from the pooled account (i.e. payments cannot be made outside of the scheme without external authorisation).

Reporting to members and contributors by SMS, for example may include notifications of:
Received payments;
Late payments;
Total amount paid per period; and
Payments made out of the account (and to whom).

The system may also make use of the same low end mobile technologies (STK, USSD, IVR) to close a scheme that has already been created, through use of authorised administrators.

Security and accountability may be improved by notifying the whole group of transactions. It may leverage existing mobile money transfer solutions to enable users to transfer funds remotely and provides a greater level of transaction traceability.

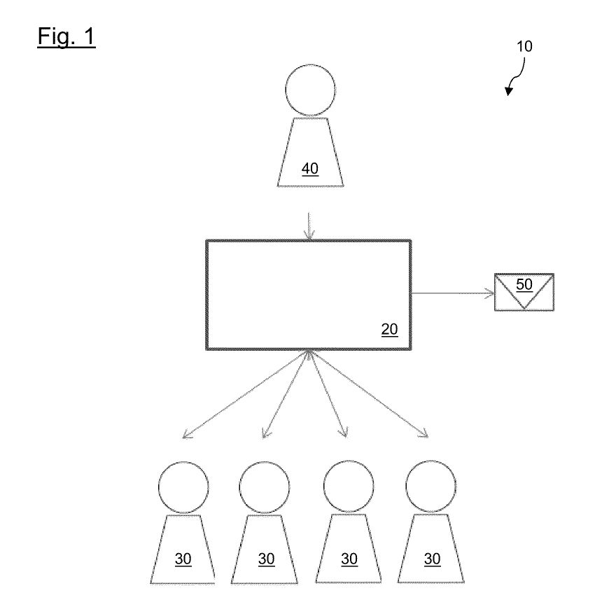

FIG. 1 illustrates schematically a method 10 of operating a savings account 20 within a mobile telephone based money transfer system. The single savings account 20 may be used to receive and distribute funds from and to contributors 30.

An administrator 40 may also be a contributor to the savings account 20 and receive funds in the same way as other contributors 30. However, the administrator 40 has further rights and privileges in administrating the account 20. For example, the administrator 40 may initialise, create or set up the account. As shown in FIG. 1, the administrator may add contributors 30 to the savings scheme. This may be achieved by the administrator 40 using menus on their own mobile telephone (not shown in this figure) to identify or select individual contributors 30. These individual contributors 30 may be identified by their mobile telephone numbers or existing personal account identifier within the mobile telephone based money transfer system. In other words, each contributor 30 may have or set up a personal account within the mobile telephone based money transfer system (e.g. M-PESA) and the administrator 40 sets up each contributor 30 such that they are associated with, belong to or part own to the savings account 20.

Each new contributor may be invited to join the savings account 20 rather than being automatically enrolled. The invitation may take the form of an SMS message 50 or other notification. The invited contributor may then accept or decline the invitation. This may be achieved by several different mechanisms based on their mobile telephone, including an SIM toolkit (SKT), USSD or IVR menu system. Preferably, accepting the invitation requires a security check so that the system can confirm that they are the owner of the personal account and associated mobile telephone. This may include the provision of their PIN, for example. The contributor 30 may also respond using SMS.

Once enrolled, the contributors 30 may commit to certain obligations and in response receive certain privileges relating to the account 20.

The specific obligations may depend on how the administrator 40 set up the account 20. For example, the obligation may be to contribute funds of a certain value at a particular frequency. The privileges or benefits may include the receipt of regular funds from the account 20, which may be issued to each contributor in turn or as and when required. Benefits may also include receipt of interest or fees when the contributed funds within the central account 20 are provided as a loan to either an existing contributor 30 or a third party outside of the savings scheme.

A distribution list of all contributors, including the administrator 40, may be stored within the system. This distribution list may be updated as and when contributors 30 enter or leave the joint savings account or joint savings wallet 20. When activity occurs relating to the account such as the addition of new members or contributors 30, or provision of payment to the account 20, then an SMS message may be sent to all entries on the distribution list.

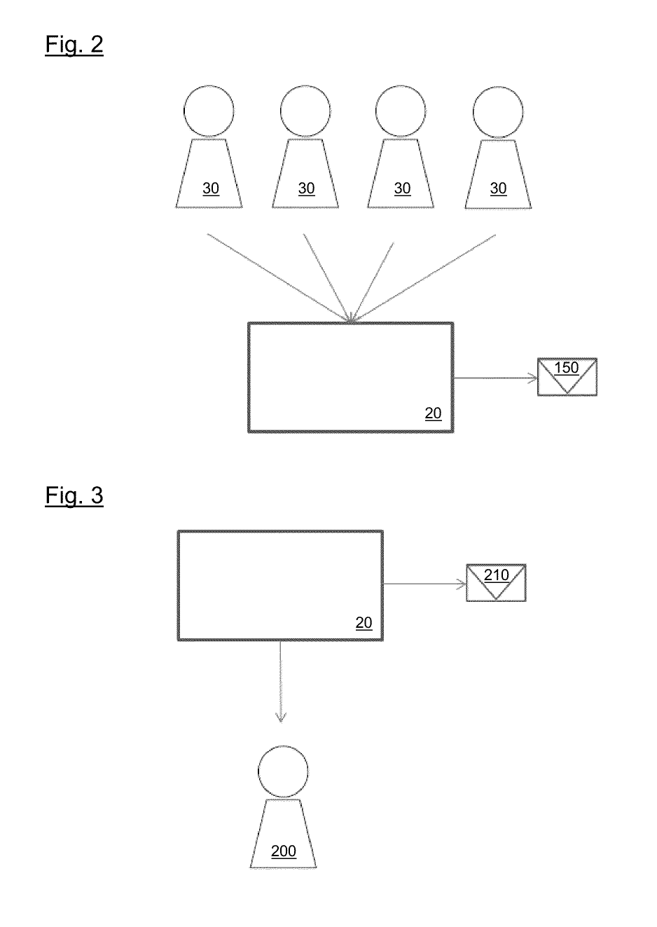

FIG. 2 schematically illustrates the process of savings customers or contributors 30 providing funds to the savings account 20. Each contributor 30 may initiate a transaction using a menu on their mobile telephone to move funds from their personal mobile money account (i.e. e-money) to the joint savings account 20. Each contributor may have existing e-money within their mobile money account within the mobile telephone based money transfer system or they may add it first by obtaining e-money from elsewhere. For example, they may credit their personal account by providing cash to a registered agent who may then convert this cash into e-money within the personal mobile money transfer system.

Funds from each contributor may be collated and added to the account 20. Restrictions may be placed on the account so that only registered participants can send money to this account 20.

A notification may be issued to each member on the maintained distribution list, preferably in the form of an SMS message 150, so that all participants receive a notification when member credits the account 20. Variations on the notification procedure may be used. These variations include only the administrator 40 receiving the messages 150 or the individual contributor receiving the messages, for example.

FIG. 3 illustrates schematically the part of the procedure or method for crediting funds from the account 20 to a recipient 200. The recipient 200 may be a contributor 30 or someone else. In any case, the recipient 200 must be a registered user within the mobile telephone based money transfer system. The transfer involves debiting the account 20 and crediting the personal account of the recipient 200 with e-money. The e-money may be redeemed in the form of cash, goods or services from an agent or used within the mobile telephone based money transfer system elsewhere. For example, the recipient 200 may purchase air time or send the money onwards to a further recipient, perhaps a family member.

According to one example implementation of the scheme, at a configurable time, funds may be debited from the account 20 and sent to the next valid recipient (i.e. a rotations scheme). Similar notification procedures may be used to send a message 210 indicating that the transaction has occurred. This message 210 may be sent to all members listed within the distribution list, the recipient 200 and/or the administrator 40.

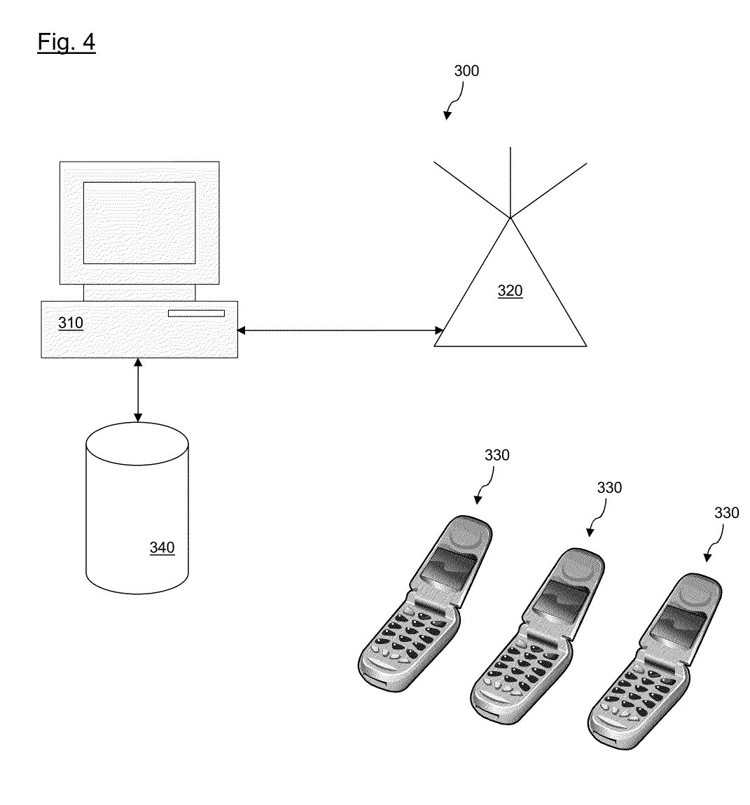

FIG. 4 shows a schematic diagram of a system 300 used to implement the method 10 of operating the savings account 20 within a mobile telephone based money transfer system. A server 310 may host the mobile telephone based money transfer system or at least a portion of it. This server 310 may be in communication with a mobile network having base stations 320. The base stations communicate with individual mobile telephones 330, which may be held by the contributors 30 and other users of the mobile telephone based money transfer system. A database 340 may be used to store information relating to individual accounts, including the account 20 of the joint savings account 20 and the personal accounts of each contributor 30, administrator 40 and any recipients 200. The database 340 may store many more accounts and associated distribution lists and other information used to administer the system 300. Several servers 310 and/or databases 340 may be used

As will be appreciated by the skilled person, details of the above embodiment may be varied without departing from the scope of the present invention, as defined by the appended claims.

For example, other types of mobile telephones may be used such as for example, smart phones. The administrator 40 may use mobile apps and so avoid the menu based systems used with more limited functionality handsets. Other notifications may be sent. Different mobile technologies may be utilised. The source of funds is described as being exclusively from the contributors but other external sources may be included. The savings account may be restricted to stay in credit at all times or be allowed to be in debit. The savings account may take the form of a pension as well. Loans may be taken from the savings account with or without payment of interest or fees, for example. Notifications may be sent when a contributor misses or can't make a payment.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of operating a savings account within a mobile telephone based money transfer system comprising the steps of:
receiving separate payments across the mobile telephone based money transfer system from a plurality of contributors; and
crediting the received separate payments to the savings account.

2. The method of claim 1 further comprising the step of recording the separate payment amounts with their corresponding contributor.

3. The method of claim 1, further comprising the step of adding a contributor to the savings account.

4. The method of claim 3, further comprising the step of generating a notification when the contributor is added to the savings account.

5. The method of claim 1, further comprising the step of generating a notification when the separate payments are received or when funds debited from the savings account.

6. The method of claim 1, further comprising the step of issuing a notification of an invitation to one or more potential contributors to the savings account.

7. The method of claim 3, wherein the notification is an SMS message to the contributors.

8. The method of claim 1, further comprising the step of creating the savings account within the mobile telephone based money transfer system before receiving the separate payments.

9. The method of claim 8, wherein the step of creating the savings account further comprises any one or more of:
specifying identities of the contributors;
specifying MSISDN of the contributors;
specifying a payment date or dates;
specifying a payment period;
specifying amount or amounts of the separate payments; and
specifying a regular interval for payments from the savings account.

10. The method of claim 1 further comprising the step of debiting funds from the savings account.

11. The method of claim 10, wherein the funds are debited at regular intervals.

12. The method of claim 10, wherein the funds are debited to the contributors in turn.

13. A mobile telephone based money transfer system comprising:
a database of a plurality of savings accounts; and
a server having logic configured to:
receive separate payments across the mobile telephone based money transfer system from a plurality of contributors; and
credit the received separate payments to one of the plurality of savings accounts.

14. The mobile telephone based money transfer system of claim 13 further comprising a notifier configured to provide notifications to the plurality of contributors when actions occur on their savings account.

15. The mobile telephone based money transfer system of claim 13 further comprising a menu provider configured to provide menus on mobile telephones of the contributors, wherein the menu is provided in the form of any one or more selected from the group consisting of:
SIM tool kit, STK;
Unstructured Supplementary Service Data, USSD; and
Interactive Voice Response, IVR.

16. A computer program comprising program instructions that, when executed on a computer cause the computer to perform the method of claim 1.

17. A computer-readable medium carrying a computer program according to claim 16.

18. A computer programmed to perform the method of claim 1.
